(19) United States
(12) Patent Application Publication
(10) Pub. No.: US 2022/0313019 A1
(43) Pub. Date: Oct. 6, 2022

(54) CHARCOAL STARTER

(71) Applicant: Kurt M. Schie, Akron, NY (US)

(72) Inventor: Kurt M. Schie, Akron, NY (US)

(21) Appl. No.: 17/221,392

(22) Filed: Apr. 2, 2021

(51) Int. Cl. A47J 37/07

(52) U.S. Cl. CPC A47J 37/079

(57) ABSTRACT

A charcoal starter wherein a pair of grates are hingedly connected within an enclosure in a manner to be movable between a first position wherein the grates are substantially planar with each other and extend cross-wise to the enclosure to hold burning charcoals above the grates and a second position wherein the grates hang vertically side-by-side with each other to allow the burning charcoals to fall out the lower end of the enclosure. The enclosure is octagonal and comprises two enclosure halves attached together.

The present invention relates generally to charcoal starters, wherein the burning of charcoal is initiated within an enclosure or chimney, and the burning charcoal is released to a grill.

One such charcoal starter is disclosed in U.S. Pat. No. 8,590,525, which discloses a charcoal igniter having a cylindrical (circular in cross section) enclosure open at each end and having a dual-action actuator assembly for rotating a pair of support rods (shown at 44 in FIG. 5) for pivoting a pair of grate members attached thereto back and forth between a charcoal-supporting position and a charcoal-releasing position. Moving an actuator arm inwardly to a first position pivots the grate members so that they are secured in the charcoal-supporting position. Moving the actuator arm outwardly to a second position pivots the grate members so that they move downwardly to the charcoal-releasing position. A handle secured to the igniter housing includes an integrated track for guiding movement of the actuator arm between the first and second positions. The actuator assembly has a locking feature for securing the handle in the first position for supporting charcoal while it is being ignited. This U.S. Pat. No. 8,590,525 and all other patents and published applications disclosed herein are hereby incorporated herein by reference.

U.S. Pat. No. 8,302,592 discloses a charcoal starter having a generally rectangular with a rounded side in cross section enclosure open at each end and a release mechanism for its perforated single hinged grate. The release mechanism consists of a release handle and release bar (seen at 12 and 5 respectively in FIG. 1) with at least one protrusion such that when the release mechanism is activated by pulling the release handle, the protrusion of the release bar aligns with a notch of the hinged grate, and the grate will then rotate about the hinge in a downward direction to allow the embers to pass downwardly to the grill.

U.S. published application 20150040886 discloses a single hinged grate charcoal starter having a cylindrical (circular in cross section) enclosure open at each end, which has a different release mechanism, wherein pulling a handle 8 (to the left in FIG. 1 thereof) moves the release member 6 (to the left in FIG. 1 thereof) thereby releasing the grate 2 so that it can pivot downwardly to release the charcoals.

U.S. published application 20170097158 discloses a single hinged grate charcoal starter having a cylindrical (circular in cross section) enclosure open at each end, which also has a release mechanism, wherein pulling a knob 32 (to the left in FIG. 2 thereof) moves a support bar (to the left in FIG. 2 thereof) thereby releasing the charcoal support plate 26 so that it can pivot downwardly to release the charcoals.

U.S. published application 20160075961 to Leveen et al discloses a 6-sided charcoal chimney made of combustible material. The charcoal briquet lighter of U.S. Pat. No. 4,503,835, which is also combustible, generally has four sides with truncated corners (FIG. 5 thereof).

U.S. Pat. No. 5,638,807 discloses a charcoal starter having a cylindrical (circular in cross section) enclosure and having a pair of grates hinged at 21A and supported at their edges by support pegs 17. A trigger 15 pulls on two wires which are connected to the pegs respectively to remove the pegs to release the grates, as seen in FIG. 2 thereof, to release the burning charcoal. As seen by comparing FIGS. 1 and 2 thereof, this starter utilizes an undesirably complex push bar 22 and spring 23B arrangement for releasing the charcoal. Moreover, due to the push bar causing an obstruction, the grates undesirably are not allowed to drop to the vertical orientation (rather, as seen in FIG. 2, to a slope of perhaps 25 degrees or so), which would undesirably block and cause a jam of the charcoal being released out of the bottom.

U.S. Pat. No. 3,167,040 discloses an automatic dump type charcoal lighter wherein a grate 24 is released by disengaging a latching rod 34 to release the burning charcoal. The charcoal lighter has a handle assembly 27.

U.S. Pat. Nos. 6,631,711 and 8,028,689 disclose folding or foldable charcoal starters.

Other art indicating the state of the art includes U.S. Pat. Nos. 3,339,505, 4,026,265, 4,282,854, 4,461,270, 4,531,507, 5,197,455, 6,009,867, 6,913,013, 9,226,615, 10,327,590, and D833815, and U.S. published applications 20080257332, 20090288653, 20120111313, 20120192852, 20130092147, 20130340740, 20170280932, 20170295994, 20180168396, and 20200275802.

It is an object of the present invention to maximize the air space available for air currents or air channels within the charcoal-filled enclosure for more efficient burning of the charcoal within the enclosure.

It is another object of the present invention to robustly and easily pivot a pair of the grate members from a charcoal-supporting position to a charcoal-releasing position.

It is a further object of the present invention to ship the charcoal starter to customers inexpensively.

The above and other objects, features, and advantages of the present invention will be apparent in the following detailed description of the preferred embodiment(s) thereof when read in conjunction with the accompanying drawings wherein the same reference numerals denote the same or similar parts.

### BRIEF DESCRIPTION OF THE DRAWINGS

FIG. 1 is a perspective view of a charcoal starter which embodies the present invention, with an upper carrying or auxiliary handle thereof in a down position.

FIG. 2 is a partial perspective view thereof, with the handle in an up position for carrying the charcoal starter.

FIG. 3 is a side view thereof, with the handle in the down position.

FIG. 4 is an upper view thereof, with the handle in the down position.

FIG. 5 is a partial perspective view thereof, with the handle in the down position, and viewed upwardly into a lower opening thereof, with grates thereof released to a second or open position.

FIG. 6 is a partial perspective view thereof, with the handle in the down position, and viewed downwardly into an upper opening thereof, with grates thereof released to the second or open position.

FIG. 7 is a detail close-up view of a portion thereof, illustrating how the grates are held and released.

FIG. 8 is a view similar to that of FIG. 7, illustrating the grates held in the closed or first position.

FIG. 9 is a blown-up view thereof, with the handle in the up position.

FIG. 10 is a perspective view of one of two identical panels of which the enclosure for the charcoal starter is composed.

FIG. 11 is an upper view of the panel.

FIG. 12 is a side view of the panel taken along lines 12-12 thereof.

FIG. 13 is a side view of the panel taken along lines 13-13 thereof.

FIG. 14 is a perspective view of one of two brackets attaching a side or main handle to the enclosure.

FIG. 15 is a perspective of one of two wooden blocks defining the side or main handle and attached to the brackets.

FIG. 16 is a perspective view of a heat shield for the side or main handle.

FIG. 17 is a perspective view of one of two brackets for attaching the upper carrying or auxiliary handle to the enclosure.

FIG. 18 is a perspective view of the upper carrying or auxiliary handle.

FIG. 19 is a perspective view of a heat shield for the upper carrying or auxiliary handle.

FIG. 20 is a perspective view of one of the grates.

FIG. 21 is a perspective view of the other of the grates.

FIG. 22 is a perspective view of the grates together in the held position.

FIG. 23 is a perspective view of the grates together in the released position.

FIG. 24 is a perspective view of a member for holding and releasing the grates.

FIG. 25 is a perspective view of a knob for manipulating the member of FIG. 24.

### DETAILED DESCRIPTION OF THE PREFERRED EMBODIMENT(S)

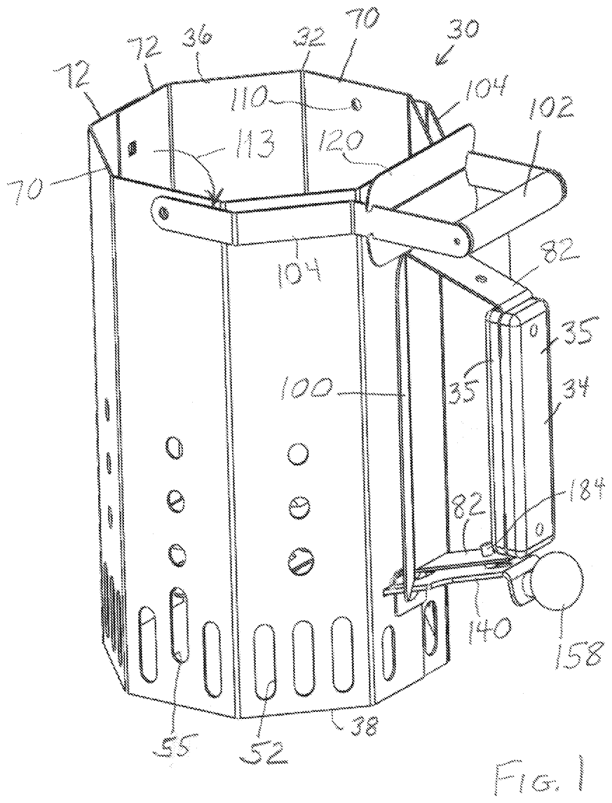

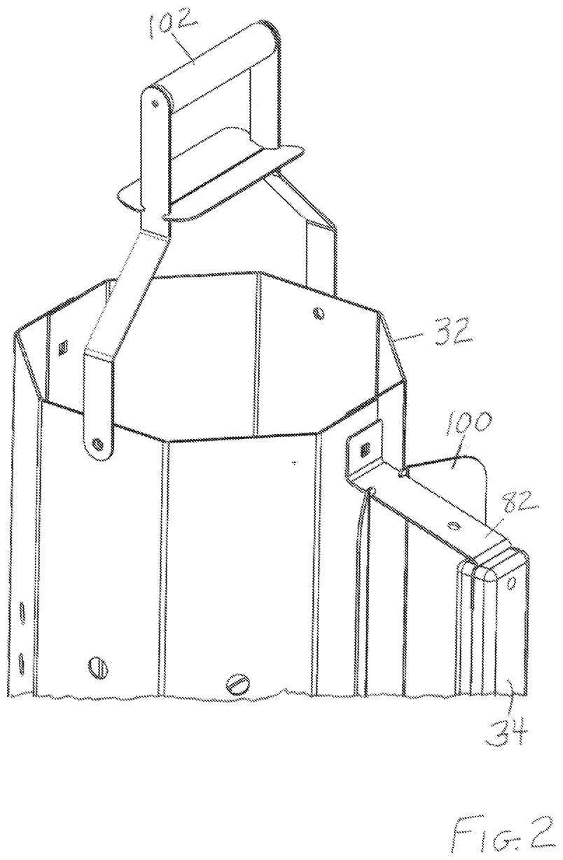

Referring to FIGS. 1 to 9, there is shown generally at 30 a charcoal starter or chimney which embodies the present invention and which includes an elongate enclosure 32. A side or primary handle 34 is attached to the enclosure 32 as discussed hereinafter. When the enclosure 32 is held or oriented upright, as seen in FIG. 1 with the handle 34 oriented vertically, the enclosure 32 extends vertically and has an open top end 36 and an open bottom end 38. Unless otherwise specified, references herein with respect to direction are with reference to the enclosure being in such an upright orientation.

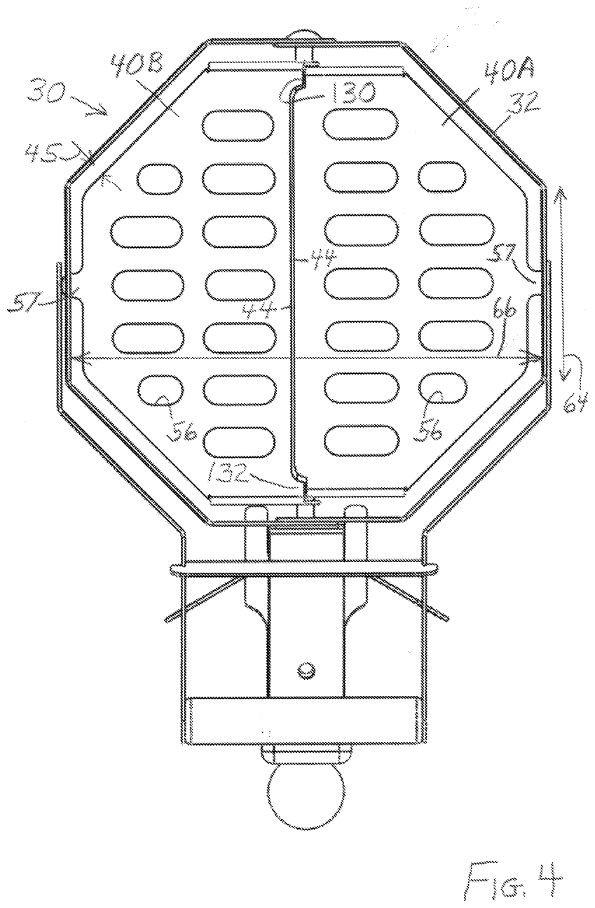

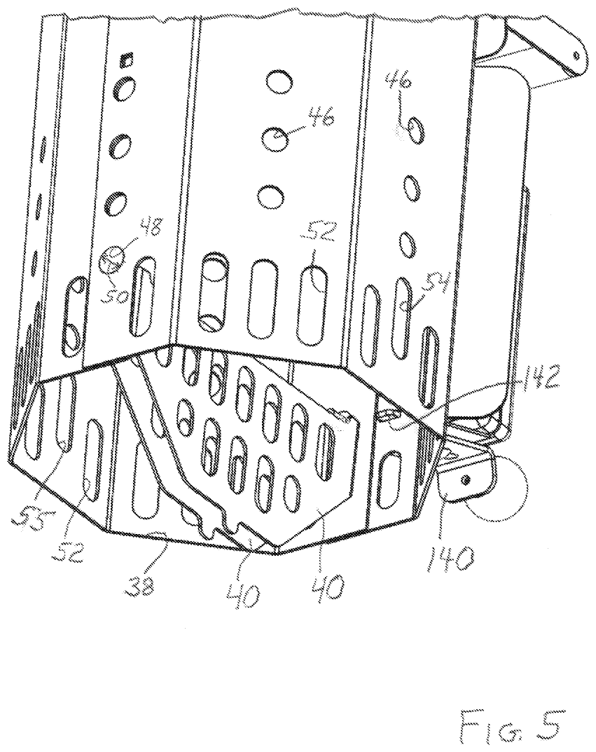

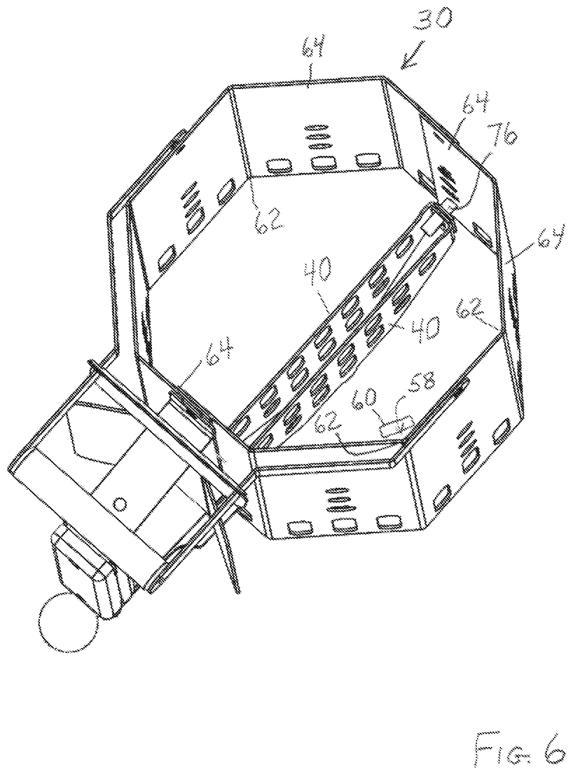

The enclosure 32 is provided with a pair of grates 40 (FIGS. 4 to 6) to contain charcoal for the initiation of burning and then to release the burning charcoal to a grill for use. Thus, the grates 40 are arranged, as hereinafter discussed, to lie horizontally (when the enclosure 32 is in its upright orientation) and co-planar with each other to together extend entirely across the enclosure 32 to together form a closed gate to contain or hold the charcoal for the initiation of burning, as seen in FIG. 4. The grates 40 are also arranged to be released from their horizontal orientation (what may be called opening of the gate) wherein the grates 40 may be said to fold downwardly, like the wings of a butterfly, to each lie vertically (when the enclosure 32 is in its upright orientation), as seen in FIGS. 5 and 6, with the grates 40 side-by-side with each other to allow the burning charcoal to be released from the enclosure 32 to a grill for use. Unlike the jamming that may occur in the charcoal starter of the aforesaid U.S. Pat. No. 5,638,807 as the burning charcoal is being released, due to the grates thereof lying downwardly at an angle to each other due to an obstruction, the grates 40 of the present invention, being unobstructed in their movements to their vertical orientations, are able to lie vertically (wherein the vertical grates are side-by-side with each other) to avoid such jamming. Unlike a single burn grate gate wherein the coals drop down along one side, the coals drop down along both sides of the folded gate whereby the burned coals that are usually on the bottom of the charcoal starter 30 will better mix with the lesser burned or unburned coals near the top of the starter 30, allowing for a more even distribution of burned-to-unburned coal mixture when dumped into the grill for use.

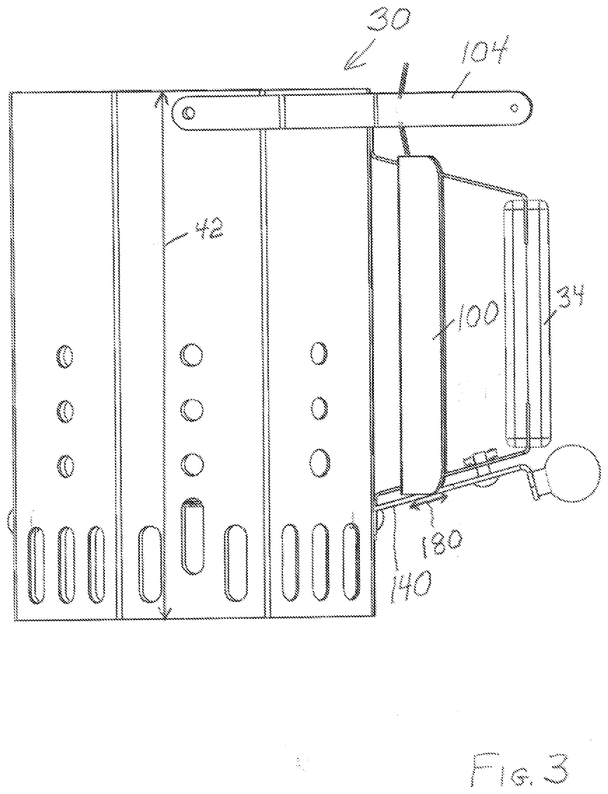

Unless stated otherwise, the components of the charcoal starter 30 are made of desirably thick steel, preferably stainless steel, or other suitable material. The enclosure 32 and grates 40 are desirably made of 18 to 20 gage stainless steel so as to be sufficiently light while still having sufficient strength. While the enclosure 32 may have any suitable height, it may have a height, illustrated at 42 in FIG. 3, of, for example, about 12 inches.

As best seen in FIG. 4, the grates 40 mate with each other along generally straight edges 44 and generally mate with or take the same shape as the shape (cross-sectionally) of the enclosure 32 to closely fit adjacent the enclosure, thereby forming the gate to adequately hold the burning charcoal, but with suitable play or gap there between, illustrated at 45, of, for example, about ¼ inch, to easily allow (without binding) the folding of the grates 40 downwardly (about edges 44), as discussed hereinafter, to the vertical positions of FIGS. 5 and 6.

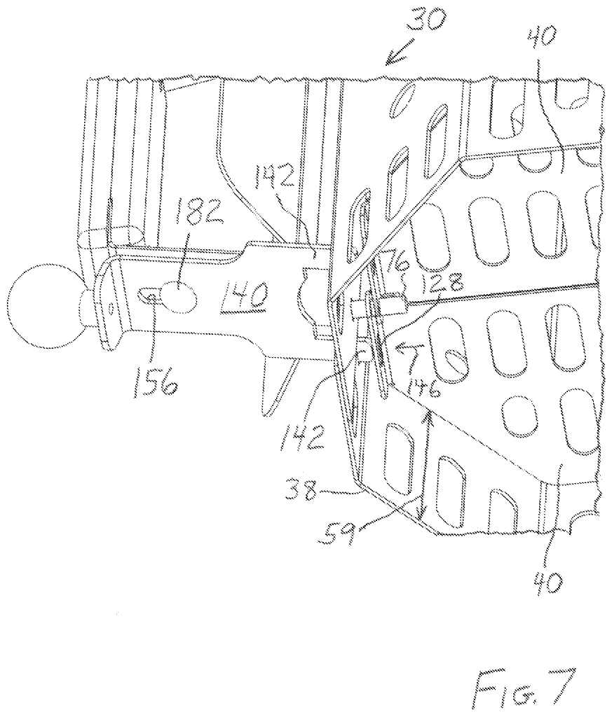

The enclosure 32 has a suitable number and size of air intake holes, illustrated at 46, above the grates 40, and suitably positioned such as illustrated around the enclosure 32. These holes 46, may have a diameter of, for example, about ½ inch and may be varied in diameter. At least one of these holes, illustrated at 48 (or, if desired but not shown, a whole row of these holes 48) is preferably large enough to receive the tip of a propane torch so that the charcoal is easier to fire. For example, hole 48 has a diameter, illustrated at 50, of ¾ inch or larger. The lower portion of the enclosure 32, i.e., the portion below the horizontal grates 40, has a suitable number and spacing of air vents, illustrated at 52 and including two higher air vents 55, of suitable size, diametrically opposite each other. The grates 40 have tabs 55 which project outwardly, extending beyond the gap 45, and are guidingly receivable in air vents 55, which are higher than the other air vents 52 to accommodate the height of the tabs 57. The grates 40 are also provided with a suitable number and size and spacing of air passages, illustrated at 56. The grates 40 are located near the bottom end 38 of the enclosure 32, i.e., a distance, illustrated at 59 in FIG. 7, of, for example, about 2 inches from the bottom end 38.

Efficient burning of the charcoals depends upon having adequate air flow in and among the charcoals, as provided by air coming in through the grate passages 56 and the enclosure passages 46 and 52 as well as the open upper and lower ends 36 and 38. It is also important for burning efficiency to have air passages between the charcoal and the sides of the enclosure 32. It has been found that the abutting of charcoal against corners of the enclosure 32 can provide suitable air passages, such as illustrated in FIG. 6 by an air passage illustrated at 58 formed by a piece of charcoal illustrated at 60 positioned at a corner, illustrated at 62, of the enclosure 32. A square in cross-section enclosure would have four corners providing with charcoals air spaces with each of the four corners, but only four corners. As the number of sides of an enclosure increases, there would desirably be more such corners for such air spaces to develop. But as the number of enclosure sides increases beyond a certain number, the enclosure would appear in cross section to be more like a circle, wherein the air passage advantage would be gradually lost. It is thus believed that the optimum number of corners 62 is eight, that below eight, there are a lesser number of corners providing air passages, and that, above eight, the effectiveness of individual air passages at the corners tapers off. Accordingly, while the enclosure 32 may be any suitable shape, it is preferably octagonal in shape, i.e., having eight sides 64 (providing the eight air current corners 62, providing the optimum number of corners 62 for maximizing the amount of space available for air currents or air passages or air channels 58 for achieving optimally efficient burning. Each side 64, which extends over the entire length 42 of the enclosure, has substantially the same width, i.e., a width, illustrated at 66, of, for example, about 3 to 3½ inches, providing a minor enclosure diameter, illustrated at 68, of about 8 inches. Unless otherwise specified, all dimensions specified here and otherwise in this specification are for exemplary purposes only and not for purposes of limitation.

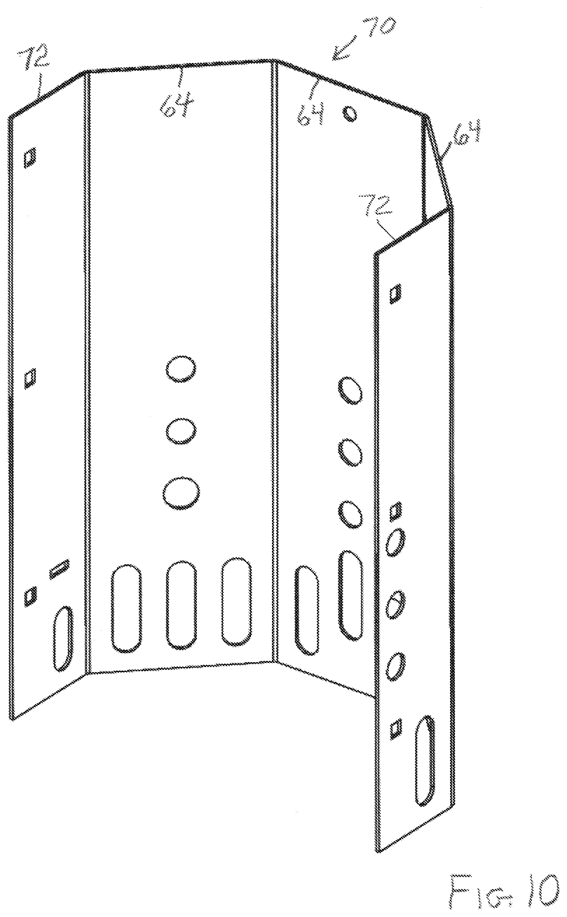

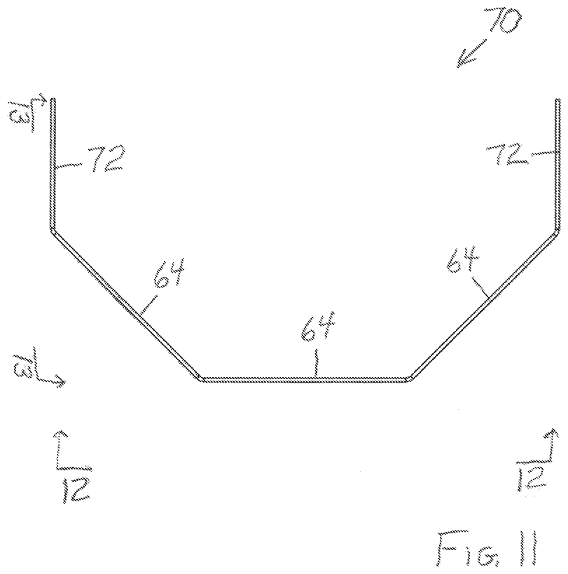

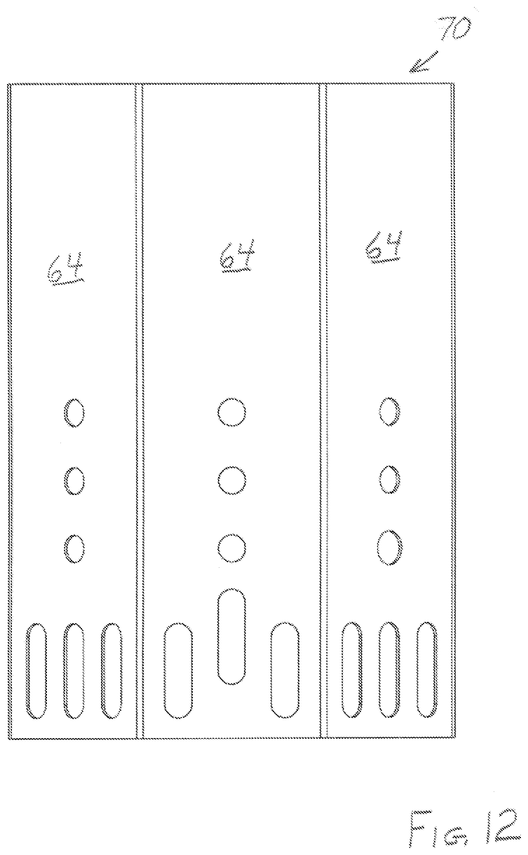

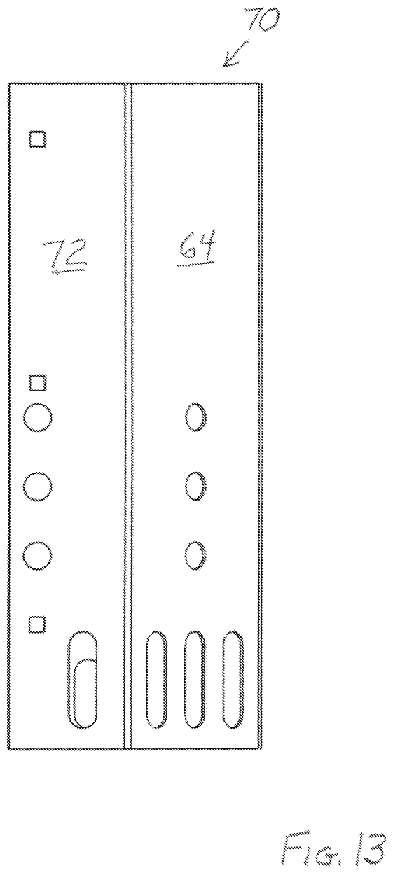

The largest part of the charcoal starter 30 is the enclosure 32, and, when assembled, would require a large box for shipment at a large shipping cost. The individual parts are preferably made (including formation of holes or openings and folding) robotically. Referring to FIGS. 10 to 13, the enclosure 32 is preferably made robotically as two substantially identical parts or halves 70 which are bolted together by the customer. By “substantially identical” is meant, for the purposes of this specification and the claims, that the halves 70 have the same approximate height and number and widths of sides formed at approximately the same angles relative to each other, as discussed in greater detail hereinafter, but may have apertures and openings and appendages and the like which differ between the halves. Each half 70 has three of the sides 64 plus two half sides 72. The half sides 72 of one half 70 are bolted to the half sides 72 of the other half 70 respectively, each by suitable fastening means, desirably three suitably vertically spaced bolts or screws 74, 75, and 76, inserted in suitable apertures, illustrated at 78, and suitable nuts 80 suitably applied. Screw 76 is longer for reasons which will be discussed hereinafter.

The charcoal starter 30 may thus be modular with the individual parts produced robotically with minimum manual labor. The enclosure parts 70 may suitably be nested (one inside the other) and the other parts, which are much smaller and discussed hereinafter, added therewith to a suitably small shipping container, for example, inexpensively in a box measuring 12″×12″×6″ (a standard USPS flat rate box), with the customer supplying the additional labor of assembly. Thus, little or no manual labor may be required at the manufacturing plant for providing the charcoal starter 30 to the customer.

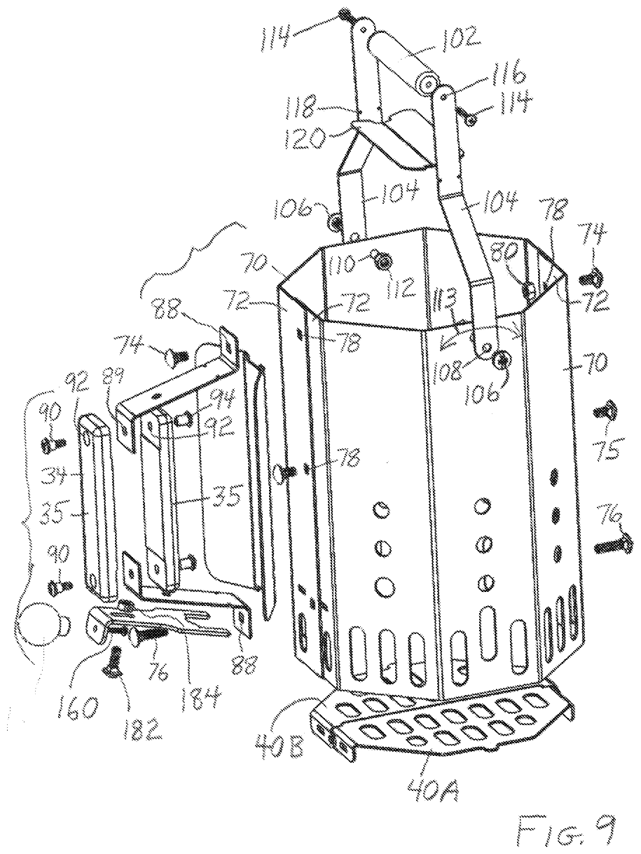

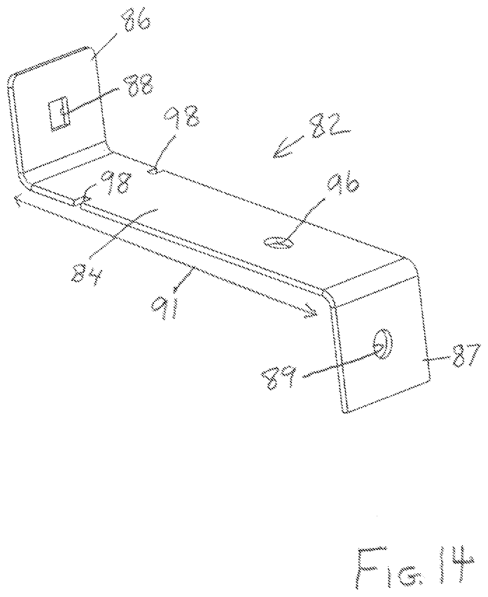

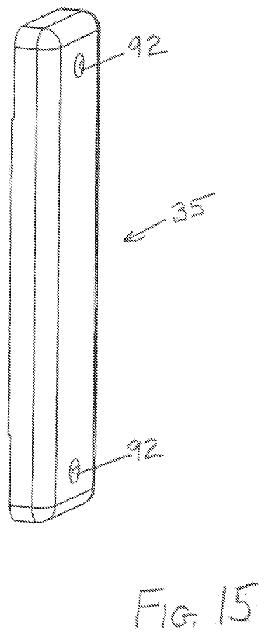

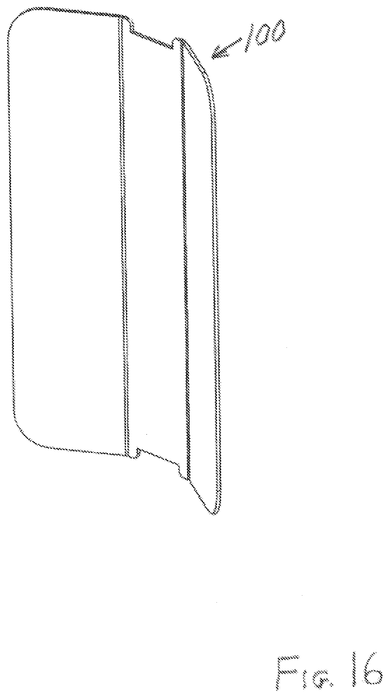

Referring to FIGS. 14 to 16 as well as FIG. 9. the handle 34 is attached to the enclosure 32 by means of two substantially identical brackets 82 each having an elongate central portion 84 for spacing the handle 34 a desired distance from the enclosure 32 and by end tabs 86 and 87 each having an aperture 88 and 89 respectively. For example, each bracket 82 has a length, illustrated at 91, of, for example, about 3¾ inches. The brackets 82 are attached to the enclosure 32 with the same bolts 74 and 76 attaching respectively two enclosure halves 72 together, which are received in apertures 88 as well as the respective enclosure half apertures 78. The handle 34 comprises two elongate pieces 35 of wood or heat resistant polymer (plastic) or other suitable material which are attached inwardly and outwardly of the tabs 87 respectively, by means of suitable bolts 90 which are received in handle apertures 92 respectively and in tab aperture 89 and suitable nuts 94 applied. An aperture, illustrated at 96, is provided in each central portion 84 for reasons which will be discussed hereinafter. Each central portion 84 also has a pair of aligned notches, illustrated at 98, in its edges respectively which snappingly receive a heat shield 100.

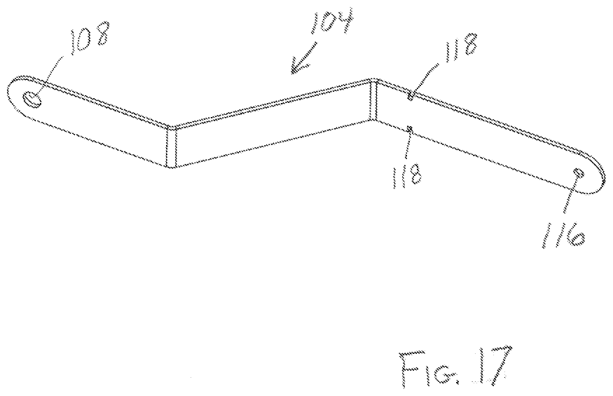

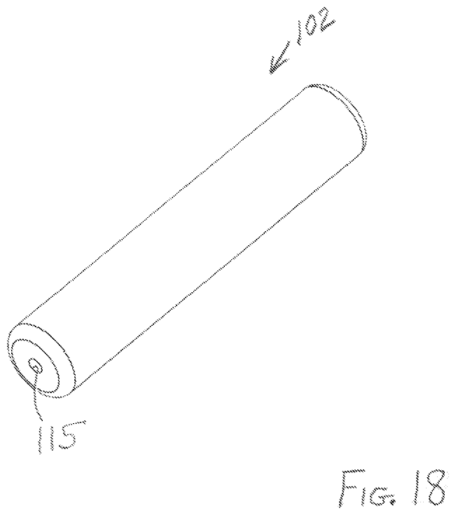

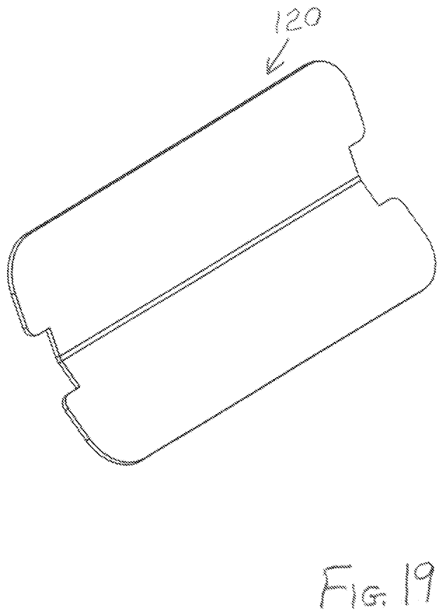

Referring to FIGS. 17 to 19 as well as FIG. 9, while the primary handle 34 is desirable for manipulating the charcoal starter 30 during use, an auxiliary handle 102 is provided for use in more easily carrying the charcoal starter 30 around when not in use and is also helpful when raising the charcoal starter 30 upward to allow the coals to dump from the bottom. A pair of brackets 104 are suitably shaped for attaching the handle 102 to the enclosure 32 adjacent the top thereof. The brackets 104 are attached to the enclosure 32 on diametrically opposite sides thereof by means of screws or bolts 106 received in apertures, illustrated at 108, in the brackets 104 respectively and in apertures, illustrated at 110, in the enclosure 32 respectively, and suitable nuts 112 applied respectively, in a manner so that the brackets 104 are pivotal, as illustrated at 113 in FIGS. 1 and 9, so that the handle 102 can be in a position for carrying, as seen in FIG. 9, and pivoted to a position, as seen in FIG. 1, to rest out of the way alongside the enclosure 32. The brackets 104 are attached to the handle 102 by suitable screws 114 received in apertures, illustrated at 116, in the brackets 104 respectively and suitably threadedly received in apertures, illustrated at 115, in the ends of the handle 102 respectively. The handles 34 and 102 are each made of a suitable material such as, for example, wood or heat-resistant polymer (plastic). Each bracket 104 also has a pair of aligned notches, illustrated at 118, in its edges respectively close to the handle 102 which notches snappingly receive a heat shield 120.

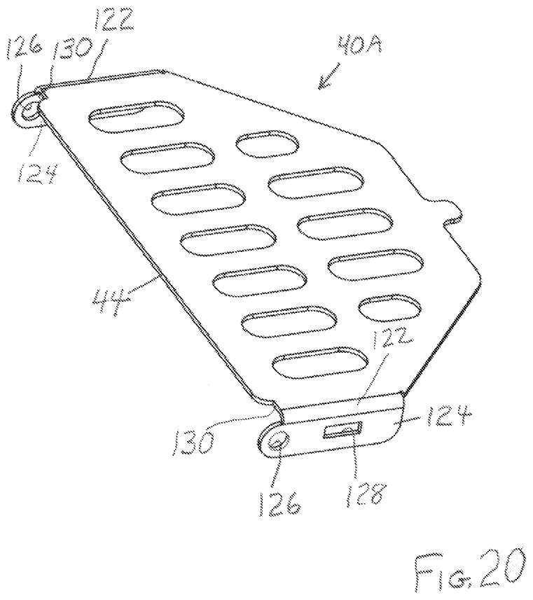

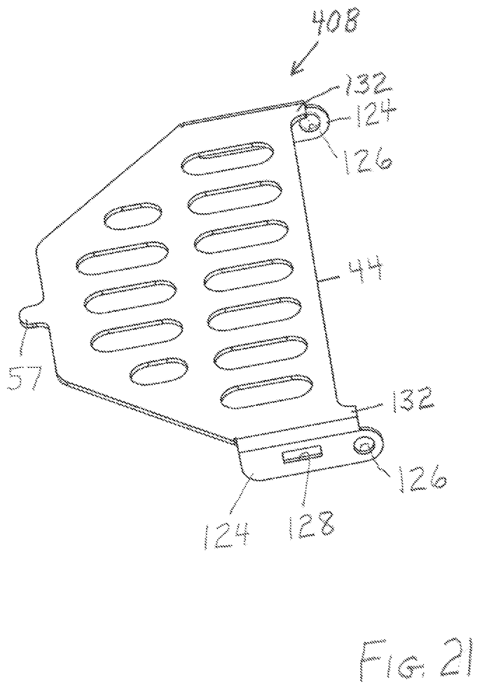

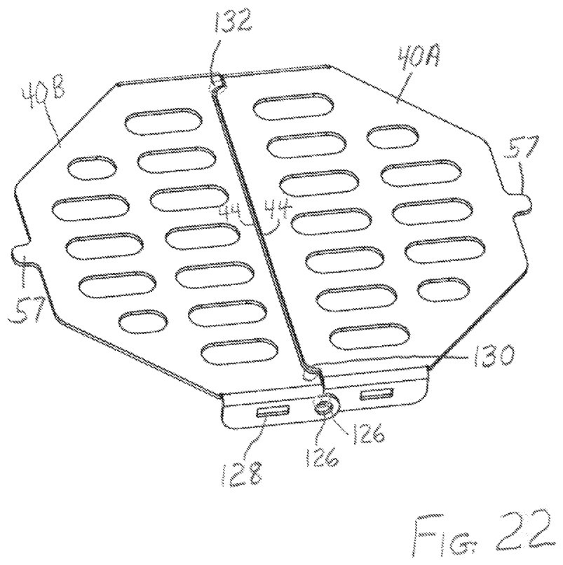

Referring to FIGS. 20 to 23, each grate 40 has a pair of opposite edges 122 which extend from its mating edge 44 perpendicular thereto (which lie along a pair of opposite walls of the enclosure 32 when the grates 40 are horizontal). A pair of tabs 124 extend from these edges 122 normal thereto or downwardly (when the charcoal starter 30 is held upright and the grates 40 horizontally oriented). These tabs 124 have apertures, illustrated at 126, which are in alignment with the mating edge 44 of the respective grate 40, and the tabs 124 extend outwardly beyond the respective mating edge 44 so that the apertures 126 may be in such alignment with the respective mating edge 44. These tabs 124 also have rectangular openings or slots, illustrated at 128, suitably spaced from the apertures 126 and whose purpose will be discussed hereinafter. As seen in FIG. 20, one of the grates 40A has notches, illustrated at 130, in its mating edge 44 at the ends thereof, and, as seem in FIG. 21, the other grate 40B has projections 132 which fit in the notches 130 respectively, as seen in FIG. 22, to maintain grate alignment.

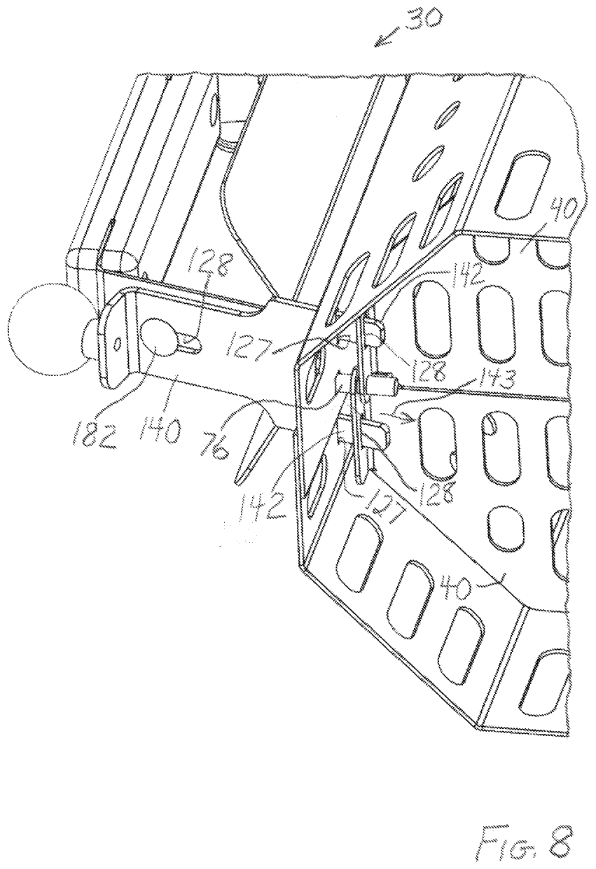

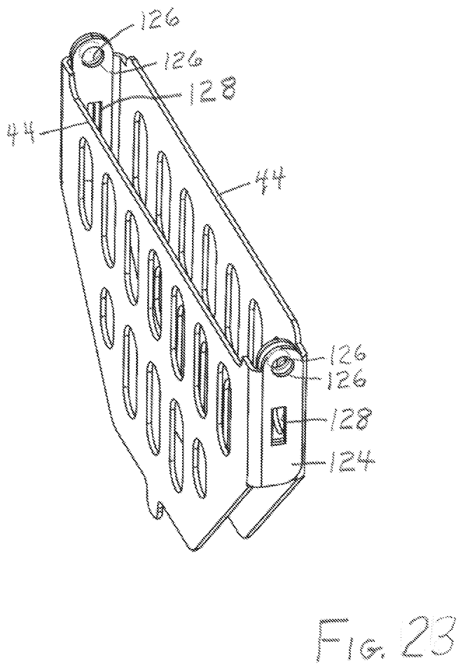

Referring to FIGS. 7 and 8, the grates 40 are hingedly attached to hingedly swing between the horizontal position of FIG. 22 and the vertical position of FIG. 23. The hinge attaching the grates 40 comprises the long screws 76 each of which is received in both apertures 126 of both grates 40 on a respective end of the mating edges 44 respectively. For the purpose of this specification and the claims, a hinge is defined as that on which something turns or depends or pivots. Thus, the grates 40 turn or depend or pivot on the shanks of screws 76, which thereby serve as a hinge. It should be understood that the hinge 76 connecting the grates 40 may be another suitable connector on which the grates 40 turn or depend or pivot, such as a movable joint wherein a pin is inserted into interlocking grooves or the like emanating from the grates respectively.

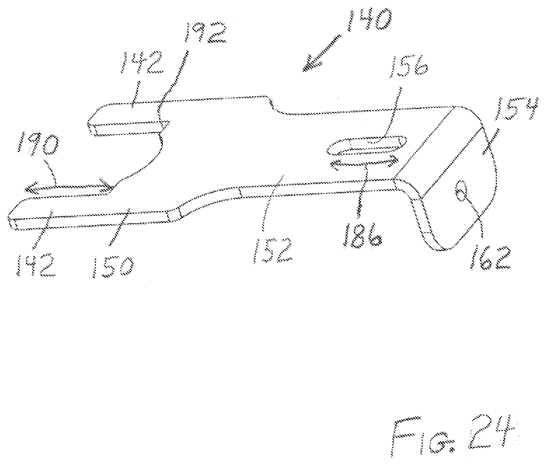

Referring to FIG. 24, there is shown a fork-like elongate member 140 having a pair of terminal prongs or spaced projections 142 on one end thereof and is movable longitudinally thereof between two positions as will be discussed hereinafter. As best seen in FIG. 8 (looking upwardly toward the bottoms of the grates 40), the prongs 142 are shown to pass through openings or slots 127 in the enclosure 32 and to have been moved inwardly, as illustrated at 143, to underlie the grates 40 respectively and to pass through the openings or slots 128 to maintain and lock the grates 40 in a first position wherein the grates are held in the held or horizontal position (with the charcoal starter 30 held upright). The prongs 142 are spaced apart a distance, illustrated at 144, which is sufficient to advantageously hold both grates 40 in the horizontal position with the same forked member 140, one prong underlying and holding one grate and the other prong underlying and holding the other grate. This distance 144 may, for example, be about 1¼ inch.

As best seen in FIG. 7, the prongs 142 are seen to have been removed from the slots 128 respectively to an outwardly position free of the grates 40, as illustrated at 146, whereby the grates 40 are free to rotate about hinge or screws 76 to fold downwardly (like the wings of a butterfly) to the second or vertical position shown in FIGS. 5, 6, and 23, to allow dumping of the burning charcoal to a grill. In this outwardly position, it should be noted that the prongs 142 are still held or retained in slots 127 of the enclosure 32.

Referring to FIG. 24, the fork member 140 has an enlarged end portion 150 containing the prongs 142 and a narrowed portion 152 having at its end a tab 154 which is normal thereto and extends downwardly, as seen in FIG. 1. The fork member 140 has centrally between the side edges of narrowed portion 152 and adjacent the tab 154 an elongate slot, illustrated at 156, whose purpose will be discussed hereinafter.

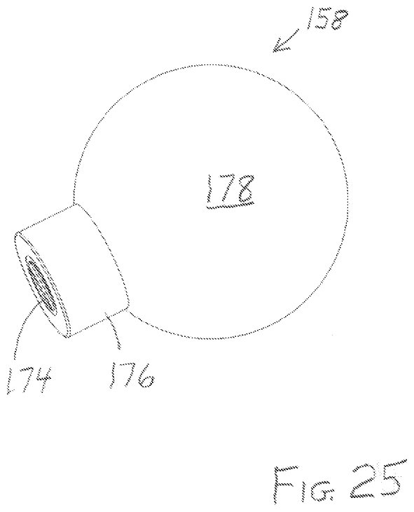

Referring to FIG. 25, a knob 158, made of a suitable material such as, for example, wood or heat-resistant polymer (plastic), and having a spherical or disc shaped handle portion 178, also made of wood or heat-resistant polymer (plastic), is attached to the tab 154 by suitable means such as a screw 160 (FIG. 9) received in aperture, illustrated at 162, in tab 54, centrally thereof, and threadedly received in aperture, illustrated at 174, centrally in an abutment 176 to the handle portion 178.

As seen best in FIGS. 3, 7, and 8, the fork member 140 is attached to lie alongside the underside of the lower one of the handle brackets 82 and is suitably attached to slide along the length thereof a limited distance, illustrated at 180, which may be, for example, about ½ inch, as follows. A screw 182 is received in fork member elongate slot 156 and in bracket aperture 96 and a nut 184 attached (such as, for example, by limiting the distance over which the shank is threaded so that the nut can be tightened to the thread-ending point) so as to allow sliding movement inwardly or outwardly by pushing or pulling on knob 158. The elongate slot 156 has a length, illustrated at 186, which is, for example, about ¾ inch. Allowing for the diameter of the shank of the screw 182, for example, about ⅛ inch, limiting movement over the length of the elongate slot 156 at each end thereof, the elongate slot 156 limits the distance over which the fork member 140 is movable to the distance 180 of, for example, about ½ inch.

The length, illustrated at 190, of each prong 142 is, for example, about ¾ inch. When the prongs 142 are fully inserted into the grate slots 128, the abutting fork member edge 192, which defines the length 190, is located so that it abuts the enclosure 32. When the fork member 140 is pulled outwardly to move outwardly of the grate slots 128 and release the grates 40 from their horizontal positions so that they can fall to the vertical position for releasing the burning charcoal to a grill, it's movement 180 being limited to about ½ inch, the end portions of the prongs 142 must remain in the enclosure slots 127. Thus, the fork member 140 is securely held in position by the enclosure slots 127 and by the screw 182 and nut 184, while allowing the desired limited and easy sliding movement.

Referring to FIG. 9, as previously discussed, the parts may be shipped to the customer inexpensively in a small box. The parts may be assembled by the customer as follows. The two enclosure halves 70 are attached together with the screws or bolts 74, 75, and 76 and their respective nuts 80, while mounting the grates 40 on the bolts 76 and while attaching the brackets 84 to the enclosure 32 with the bolts 74 and 76. The primary handle 34 is attached to the brackets 84, and the heat shield 100 attached to the brackets 84. The prongs 142 are received in the enclosure slots 127 respectively, and the fork member 140 attached to the lower bracket 84. The knob 158 is attached to the fork member 140. The brackets 104 are attached to the enclosure 32 and to the secondary handle 102, and the heat shield 120 attached to the brackets 104. In order to put charcoal into the enclosure 32, the grates 40 are rotated about bolts 76 upwardly and the knob 158 is pushed inwardly to move the fork member 140 inwardly until the prongs 142 are received in or engage the slots 128 in the grates 40 respectively. Charcoal may then be placed over the now horizontal grates and ignited. When the charcoal is sufficiently burning, the charcoal igniter 30 is held over a grill, by holding the primary handle 34, and the knob 158 is pulled to pull the prongs 142 out of the slots 128, whereupon the grates 40 fall by gravity to the vertical side-by-side position, thereby releasing the burning charcoal to the grill for their use. The handle 102 may be used for transporting the charcoal starter to a location for its use or for otherwise carrying it around.

It should be understood that, while the present invention has been described in detail herein, the invention can be embodied otherwise without departing from the principles thereof, and that such other embodiments are meant to come within the scope of the present invention as defined by the appended claims.

What is claimed is:

1. A charcoal starter comprising
an elongate enclosure having open upper and lower ends,
a hinge intermediate said upper and lower ends, and
a pair of grates connected to said hinge in a manner to be movable between a first position wherein said grates are substantially planar with each other and extend cross-wise to said enclosure to hold burning charcoals in said enclosure above said grates and a second position wherein said grates are released from said first position to hang vertically from said hinge side-by-side with each other to allow the burning charcoals to fall out said lower end of said enclosure.

2. A charcoal starter according to claim 1 further comprising means for holding said grates in said first position and for releasing said grates from said first position to fall to said second position, said means for holding and releasing said grates comprising an elongate member having a pair of terminal prongs and movable longitudinally of said elongate member between a first position wherein said prongs at least partially underlie said grates respectively on opposite sides respectively of said hinge to maintain said grates in said first position of said grates and a second position wherein said prongs are removed from at least partially underlying said grates to allow said grates to fall to said second position of said grates.

3. A charcoal starter according to claim 2 wherein said enclosure has eight faces providing an octagonal enclosure shape, wherein each of said eight faces extends length-wise from said upper end to said lower end, and wherein all of said eight faces have substantially the same width.

4. A charcoal starter according to claim 2 wherein said enclosure includes two substantially identical enclosure halves attached together and each extending from said upper end to said lower end.

5. A charcoal starter according to claim 2 wherein said hinge comprises two diametrically opposed and aligned screws extending into said enclosure and upon which said grates are rotatable.

6. A charcoal starter according to claim 2 wherein said grates have slots respectively on opposite sides respectively of said hinge for receiving said prongs respectively to hold said grates in said first position of said grates, and wherein said prongs are movable out of said slots to allow said grates to fall to said second position of said grates.

7. A charcoal starter according to claim 2 further comprising a pair of slots in said enclosure for receiving said prongs, a handle, a pair of brackets extending outwardly from said enclosure and attaching said handle to said enclosure, wherein said elongate member has an elongate opening extending longitudinally thereof, wherein at least one of said brackets has an aperture, wherein a screw is received in said aperture and said elongate opening and a nut applied to said screw thereby attaching said elongate member to said at least one bracket while allowing sliding movement of said elongate member relative to said at least one bracket over a predetermined distance in a direction into and out of said enclosure, and wherein said predetermined distance is such that said prongs are maintained in said enclosure slots over the entirety of said sliding movement of said elongate member.

8. A charcoal starter according to claim 7 wherein said grates have slots respectively on opposite sides respectively of said hinge for receiving said prongs respectively to hold said grates in said first position of said grates, and wherein said prongs are movable out of said slots in said grates during said sliding movement of said elongate member to allow said grates to fall to said second position of said grates.

9. A charcoal starter according to claim 8 wherein said hinge comprises two diametrically opposed and aligned screws extending into said enclosure.

10. A charcoal starter according to claim 1 further comprising a first handle, a first pair of brackets extending outwardly from one side of said enclosure and rigidly attaching said first handle to said enclosure whereby for holding the charcoal starter upright for use, a second handle, and a second pair of brackets pivotly attached to diametrically opposite sides respectively of said enclosure adjacent said upper end thereof whereby for use in carrying the charcoal starter around.

11. A charcoal starter for initiating burning of charcoals and releasing the burning charcoals, the charcoal starter comprising an elongate enclosure having open upper and lower ends for containing charcoals therein for initiating burning of the charcoals therein, wherein said enclosure has eight faces providing an octagonal enclosure shape, wherein each of said eight faces extends length-wise from said upper end to said lower end, and wherein all of said eight faces have substantially the same width.

12. A charcoal starter according to claim 11 wherein said enclosure includes two substantially identical enclosure halves attached together and each extending from said upper end to said lower end.

13. A charcoal starter according to claim 12 wherein each of said enclosure halves includes three of said faces and two face portions, wherein said two face portions of one of said enclosure halves are attached to said two face portions of an other of said enclosure halves respectively to define two of said faces.

14. A charcoal starter according to claim 11 further comprising at least one grate intermediate said upper end and said lower end, wherein said at least one grate is movable between a first position wherein said at least one grate is oriented generally horizontally to hold burning charcoals in said enclosure above said at least one grate and a second position wherein said at least one grate is oriented vertically to allow the burning charcoals to fall out said lower end of said enclosure.

15. A charcoal starter according to claim 11 further comprising
a hinge intermediate said upper and lower ends, and
a pair of grates connected to said hinge in a manner to be movable between a first position wherein said grates are substantially planar with each other and extend cross-wise to said enclosure to hold burning charcoals in said enclosure above said grates and a second position wherein said grates are released from said first position to hang vertically from said hinge side-by-side with each other to allow the burning charcoals to fall out said lower end of said enclosure.

16. A kit for assembly into a charcoal starter, the kit comprising
two substantially identical halves of an elongate enclosure having upper and lower open ends, wherein each of said halves extends from said upper end to said lower end, and said halves are attachable together,
a handle for holding the enclosure upright,
a pair of brackets each of which is attachable to one side of the enclosure and to said handle whereby to space said handle from said enclosure, and
a pair of planar grates hingedly attachable to the enclosure to swing between a first position wherein said grates are planar with each other and extend across said enclosure for holding charcoals in said enclosure for initiating burning thereof and a second position wherein said grates hang vertically side-by-side with each other to allow release of the burning charcoals from the enclosure.

17. A kit according to claim 16 further comprising an elongate member attachable to one of said brackets to be movable between a first position to hold said grates in said first position of said grates and a second position to allow hanging of said grates in said second position of said grates.

18. A kit according to claim 16 wherein each of said enclosure halves is folded to have three faces and two face portions, wherein said two face portions of one of said enclosure halves are attachable to said two face portions of an other of said enclosure halves respectively to define two additional faces, wherein all of said faces are substantially identical.

19. A kit according to claim 16 further comprising a heat shield attachable to said brackets to lie between the enclosure and said handle to shield said handle from heat from said enclosure.

20. A kit according to claim 16 further comprising an other handle and an other pair of brackets attachable to said other handle and pivotly attachable to diametrically opposite sides respectively of the enclosure adjacent said upper end thereof whereby for carrying the charcoal starter around.
